(19) United States
(12) Patent Application Publication
(10) Pub. No.: US 2015/0118640 A1
(43) Pub. Date: Apr. 30, 2015

(54) Intra Oral Dental Motion Recording Device and Method for the Digital Diagnosis, Computer Design and Manufacture of Dental Devices

(71) Applicant: Stephen Michael Schmitt, San Antonio, TX (US)

(72) Inventor: Stephen Michael Schmitt, San Antonio, TX (US)

(21) Appl. No.: 14/527,595

(22) Filed: Oct. 29, 2014

Related U.S. Application Data
(60) Provisional application No. 61/962,017, filed on Oct. 29, 2013.

(51) Int. Cl. A61C 19/045; A61C 9/00

(52) U.S. Cl. CPC A61C 19/045; A61C 9/0006; A61C 9/004
USPC 433/37; 433/69; 433/214

(57) ABSTRACT

An intra oral dental device and method for recording the 3D envelope of motion of a patient and translating the recording into digital information used to diagnose, computer design and manufacture dental restorations. The dental device is comprised of upper and lower tracing members having tracing pins on one member and complementary recording material on the other. The method includes forming a set of intra oral gothic arch tracings to define the 3D envelope of motion, converting the tracings to a digital data set reproducing the motion, and using the data to create a virtual model of the patient and the jaw motion. The data is used to mill articulator housings to reproduce jaw motion, to virtually position and shape virtual teeth in conformity with the patient's jaw motion, and to mill the completed dental prosthesis insuring teeth contacting surfaces are in harmony with the patient's jaw motion.

### CROSS REFERENCE TO RELATED APPLICATIONS

This original non-provisional application claims priority to and the benefit of U.S. provisional application Ser. No. 61/962,017, filed Oct. 29, 2013, and entitled “Dental Apparatus and Method for the Digital Diagnosis, Computer Design and Manufacture of Dental Devices,” which is incorporated by reference herein.

### STATEMENT REGARDING FEDERALLY SPONSORED RESEARCH OR DEVELOPMENT

None.

### BACKGROUND OF THE INVENTION

1. Field of the Invention

This invention is related to dental recording devices, and more particularly to an intra oral dental recorder and related method for recording, scanning and digitizing the unique envelope of motion of a dental patient's jaw for use in the construction of dental devices.

2. Description of the Related Art

For over two hundred years, most if not all dental devices have been made by hand using artisan type manual labor. Recently, digital methods of imaging patients using cone-beam computed tomography (CBCT), laser, light and ultra sound scanning and contact digitizing have transformed the process of making these devices. Three dimensional computer numerical control milling and additive manufacturing technologies are used extensively in dentistry and it appears that almost all devices in the future will be manufactured using digital techniques.

The human jaw is capable of complex motion because it is unique in that the mandible is rigidly attached to two moveable surfaces, or condyles. The movement of the jaw is not just a hinge motion; it can also have translation motion and rotation motion of the condyles in the glenoid fossae, the depression in the temporal bone that articulates with the condyles. This jaw motion is also constrained by ligaments, the meniscus and muscles. Due to these intricate factors, jaw motion is unique to each patient, and, as such, is complex and difficult to record and reproduce. These factors result in a unique three dimensional envelope of motion for any given patient.

In prior art, intra oral tracing devices have been used to shape moldable material with scribing or tracing pins to create what is known as a gothic arch tracing. A set of at least three such gothic arch tracings can accurately describe the unique three dimensional envelope of movement of a specific patient. These tracings were then used to mold material contacting the condylar surfaces of an articulator or to mold material on other types of cast holding devices to reproduce the patient's movement. With the advent of digital manufacturing, a physical articulator is not needed but accurate digital recording of a patient's jaw movement is.

Several new companies have developed processes to manufacture dentures using milling or additive manufacturing. However, a simple and cost effective method of recording jaw motion and a method of translating that recording into useful digital data have not yet been developed. All present digital recording devices are complex, expensive and do not allow for direct use in the digital manufacture of dental devices, such as dentures. There is a need for an economical device and method that faithfully and digitally records the position of the upper and lower impressions made with traditional impression materials or digital impressions (scans) of the patient and records the movement of the mandible and its neuro-muscular influences in a digital form.

### BRIEF SUMMARY OF THE INVENTION

The present invention is an intra oral gothic arch tracing and dental motion recording device and method for recording the three dimensional envelope of motion of a patient and translating the recording into digital information which is used to diagnose, computer design and manufacture dental restorations. The dental device is comprised of upper and lower gothic arch tracing members having scribing or tracing pins on one member and complementary recording material on the other. The method includes forming a set of intra oral gothic arch tracings to define the three dimensional envelope of motion, converting the tracings to a digital data set that faithfully reproduces that motion, and using the data to create a virtual model of the patient and the jaw motion of the patient for constructing dentures. The data may also be used to mill articulator housings to faithfully reproduce jaw motion and to virtually position virtual teeth and shape them in conformity with the patient's jaw motion. The data can also be used to mill the completed dental prosthesis to insure the contacting surfaces of the teeth are in harmony with the patient's jaw motion.

It is an object of this invention to provide an improved method for constructing dentures.

It is another object of this invention to provide an improved apparatus for constructing dentures, including an intra oral tracing apparatus.

It is yet another object of this invention to provide a method and apparatus for constructing dentures, wherein movements of the jaw can be recorded and translated into digital data that identically reproduces that movement.

It is yet another object of this invention to provide a method and apparatus to join digital scan data from different scanning devices and systems to create a virtual computer model of the patient.

It is yet another object of this invention to use the digital data of a patient's jaw motion to mill condylar housings for a simple condylar articulator whereby the movement of the articulator may be confined to the envelope of motion, i.e., movement of the lower jaw as recorded in the sagittal (or vertical) and horizontal planes, of the patient.

It is yet another object of this invention to use the digital data about a patient's jaw motion to create a virtual upper and lower model of a patient's jaw that moves in an identical manner as the patient's jaw recording and to set virtual teeth to create a digital denture in harmony with the patient's jaw motion.

It is yet another object of this invention to digitally mill the surfaces of manufactured dentures such that the teeth are in harmony with the patient's jaw movement and the type of contacting occlusal relationship indicated for the patient.

### BRIEF DESCRIPTION OF THE SEVERAL VIEWS OF THE DRAWINGS

FIG. 1 is a top view of the lower gothic arch tracing member of the present invention.

FIG. 2 is a bottom view of the upper gothic arch tracing member of the present invention.

FIG. 3 is a rear elevated view of the intra oral gothic arch dental motion recording device of the present invention showing upper and lower gothic arch tracing members in an opposing complementary configuration.

FIG. 4 is an occlusal view of the lower gothic arch tracing member of FIG. 1 with recording material and illustrating the gothic arch tracings. The lower handle has been removed.

FIG. 5 shows an occlusal view of a single anterior gothic arch tracing from FIG. 4 made on the lower gothic arch tracing member.

FIG. 6 depicts the upper and lower gothic arch tracing members of the present invention in centric relation and the digital scans made therefrom.

FIG. 7 is a flow chart of the method of the present invention for recording jaw motion and scanning the tracing members.

FIG. 8A depicts an anterior gothic arch digital scan of the present invention in an .stl format.

FIG. 8B is a cross sectional view of FIG. 8A illustrating the channel created by the tracing pin of the present invention in an .stl format.

FIG. 9 depicts the three gothic arch tracings of FIG. 4 from the .stl scan of the lower gothic arch tracing member of the present invention.

FIG. 10 is an occlusal view of upper virtual teeth set in relation to the virtual upper impression of the present invention.

FIG. 11 is an occlusal view of a mandibular molar denture tooth.

FIG. 12 is a perspective view of a dental articulator.

### DETAILED DESCRIPTION OF THE INVENTION

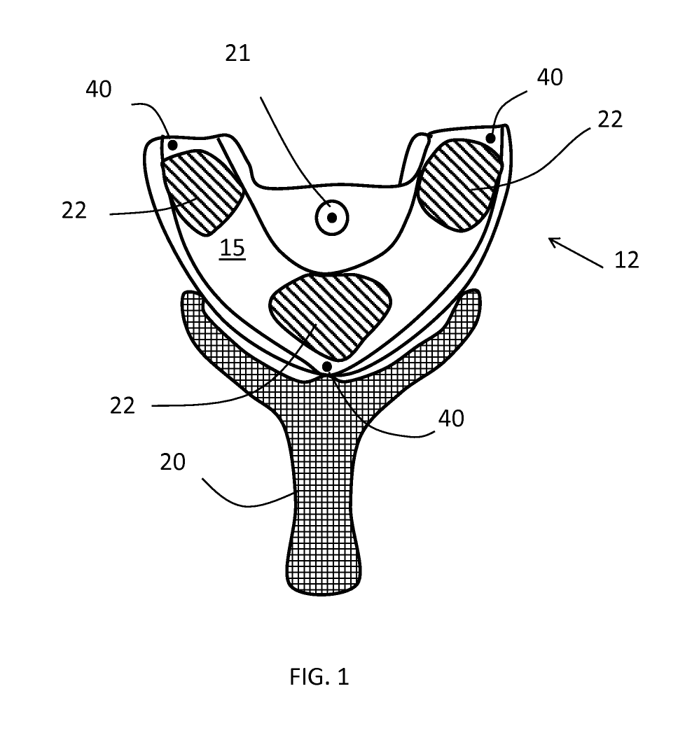

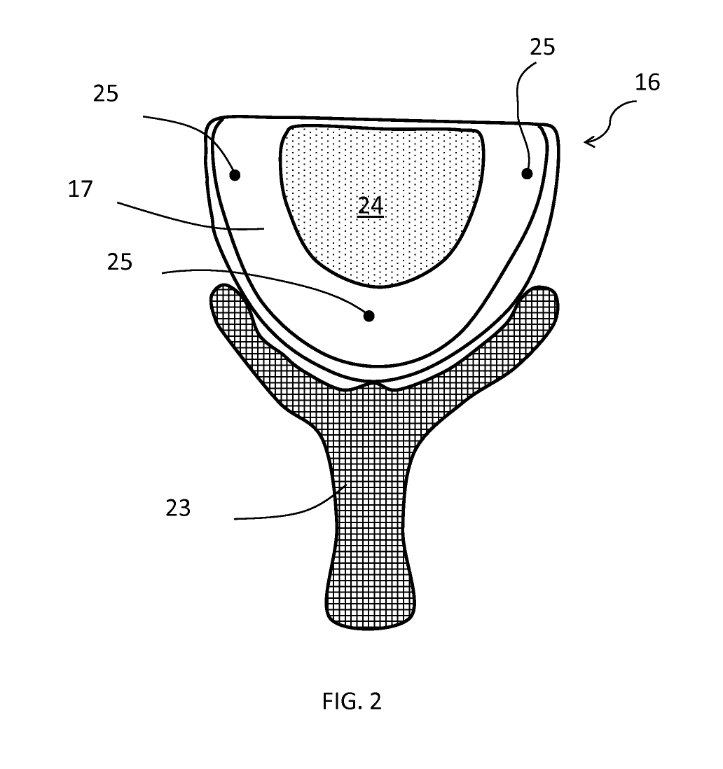

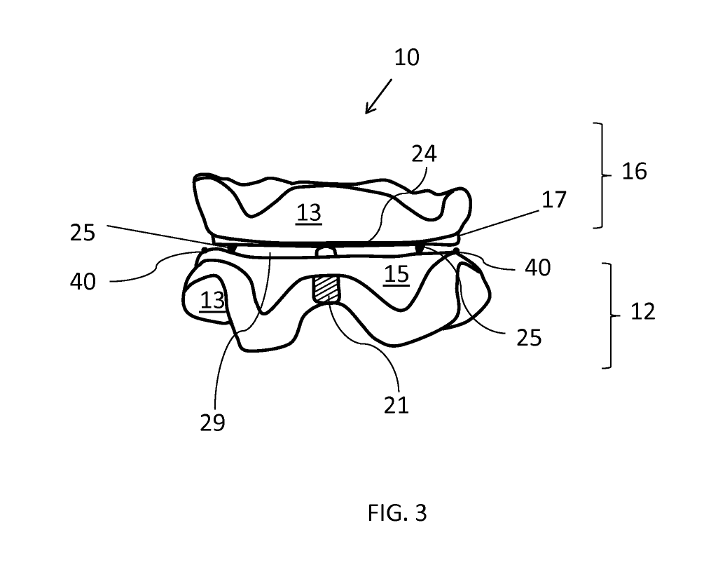

An intra oral gothic arch dental motion recording device 10 according to the present invention is comprised of lower gothic arch tracing member 12 and upper gothic arch tracing member 16, as shown in FIGS. 1 and 2. Referring now to FIG. 1, lower gothic arch tracing member 12 has handle 20 removably attached to lower tray 15. Handle 20 can be used to ideally position lower gothic arch tracing member 12 in a patient's mouth (not shown). Dental impression material 13 (see FIG. 3) is placed in lower tray 15 and positioned over the lower soft tissues and teeth to retain lower gothic arch tracing member 12 and to record the shape of the lower teeth and tissue. Dental impression material 13 may be polyvinyl siloxane or other suitable material. Handle 20 can easily be removed, if necessary.

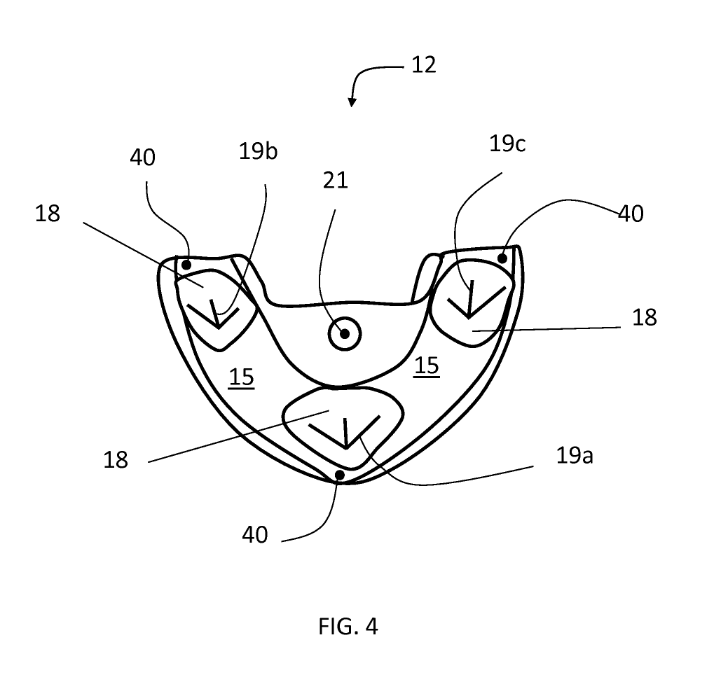

Lower gothic arch tracing member 12 has at least three receiving areas 22 at various locations on and within lower tray 15. Receiving areas 22 are depressions or recesses within lower tray 15 for the placement of recording material 18 (see FIG. 4). Threaded post 21 is centrally located within and traverses lower tray 15. Threaded post 21 can be moved up or down to record movement at the correct amount of jaw opening which has previously been determined. At least three radiographic fiducial markers 40 are attached to lower tray 15 at locations adjacent to receiving areas 22.

Referring now to FIG. 2, upper tray 17 of upper gothic arch tracing member 16 has contact plate 24 which contacts threaded post 21 when upper tray 17 is in the mouth (not shown). The configuration of contact plate 24 may be flat, curved or arched and still be within the contemplated invention. Upper handle 23 removably attached to and extending distally from upper tray 17 is used to position upper tray 17 in the mouth (not shown) with dental impression material 13 to stabilize upper gothic arch tracing member 16 and to record the shape of the upper tissue or teeth.

Three or more scribing or tracing pins 25 are rigidly attached to upper tray 17 in a triangular configuration. For example, one tracing pin may be located at an anterior position of the mouth while the other two tracing pins are located at posterior positions on either side of the mouth. The plurality of tracing pins 25 are used to cut and shape recording material 18 located on lower intra oral gothic arch tracing member 12 (see FIG. 4) to record the three dimensional border movements, i.e., envelope of motion, of the patient's mandible.

In the preferred embodiment, threaded pin 21 is on lower tray 15 and contact plate 24 on upper tray 17. However, the two components (i.e., threaded pin 21 and contact plate 24) can be reversed such that threaded pin 21 is on upper tray 17 and contact plate 24 is on lower tray 15, if preferred. The same is true for tracing pins 25 and receiving areas 22. In the preferred embodiment, tracing pins 25 are on upper tray 17 and receiving areas 22 on lower tray 15 but the positions can be reversed with receiving areas 22 on upper tray 17 and tracing pins 25 on lower tray 15. Finally, radiographic fiducial markers 40 are located on lower tray 15 but can also be on upper tray 17 to accomplish the same purpose.

Fiducial markers 40 have a shape, e.g., round, that can be precisely located in a digital scan of lower gothic arch tracing member 12 with light, laser, cone-beam computed tomography (CBCT) or contact digitizing. Only fiducial markers 40 are radiolucent and will be detected with radiographic imaging. The remaining portions of upper gothic arch tracing member 16 and lower gothic arch tracing member 12 of intra oral gothic arch dental motion recording device 10 are radiolucent and will not distort radiographic images. In the preferred embodiment, intra oral gothic arch dental motion recording device 10 is made of a radiolucent plastic, such as carbon fiber or other similar material.

FIG. 3 is a rear view of intra oral gothic arch dental motion recording device 10 illustrating how upper and lower gothic arch tracing members 12, 16 would appear and be aligned relative to each other in the mouth. Upper gothic arch tracing member 16 and lower gothic arch tracing member 12 are aligned in centric position relation with respect to each other. Centric relation is the position of the mandible in relation to the maxilla when the condyles are situated as far anteriorly and superiorly as possible within the glenoid fossa. At centric relation, the condyles are both simultaneously seated most superiority in their respective glenoid fossa.

Upper tray 17 of upper gothic arch tracing member 16 is stabilized in the mouth with impression material 13, such as polyvinyl siloxane or other suitable material, that conforms to and records the shape of the upper oral tissue.

Contact plate 24 provides a vertical stop for threaded post 21 at the proper vertical dimension of occlusion (VDO) for any given patient. At the proper VDO, the patent's teeth are in maximum intercuspation, i.e., where the cusps of the teeth of both the top set and the bottom set of teeth are fully interposed with each other. Adjustments in the vertical contact position may be made by turning threaded post 21 in a manner similar to turning a screw. For example, turning threaded post 21 in a clockwise direction extends threaded post 21 further from lower tray 15, expanding the distance between upper gothic arch tracing member 16 and lower gothic arch tracing member 12. Conversely, rotating threaded post 21 in a counterclockwise rotation minimizes the distance between upper gothic arch tracing member 16 and lower gothic arch tracing member 12.

Lower tray 15 of lower gothic arch tracing member 12 is also stabilized with impression material 13 which conforms to and records the shape of the lower oral tissues. Upper tracing pins 25 capture the right lateral, left lateral and protrusive mandibular movements, i.e., envelope of motion, in recording material 18. Recording material 18 is applied at the same locations where receiving areas 22 (not shown) are located (see FIG. 1). Recording material 18 may be methyl-methacrylate resin, dental modeling compound, plaster, wax, light curable composite or any other suitable recording material.

Intra oral gothic arch dental motion recording device 10 of the present invention is universally sized, e.g., small, medium and large, to accommodate and be used with patients of various ages and sizes from children to adults.

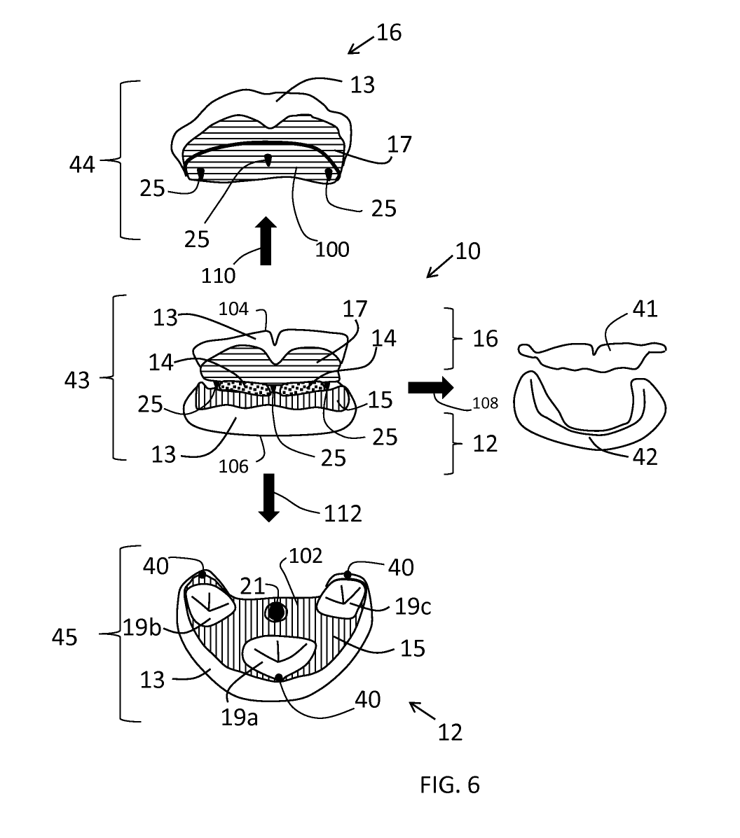

In a procedure well known in the dental art, the patient is guided in mandibular movements to cut border movements in the recording material. When the dental professional, e.g., a dentist, is guiding the patient in this procedure, the patient is asked to move the jaw forward and backward, as well as to the left and to the right. The result is a gothic arch tracing with the centric relation position at the apex of the gothic arch tracing. It is useful in the process of making dentures to record this centric position by requesting the patient to move back until the apex position is reproduced and a locking material 14, such as polyvinyl siloxane or other similar bite registration material, is injected into space 29 between upper contact plate 24 and lower threaded post 21, as shown in FIGS. 3 and 6.

In the preferred embodiment, the patient can have a CBCT scan made with upper gothic arch tracing member 16 and lower gothic arch tracing member 12 locked in this centric position (see FIG. 6). Radiographic fiducial markers 40 can then be located in the CBCT scan as well as in the scanning of upper and lower gothic arch tracing members 12, 16 out of the mouth. This makes it possible to join data from the CT scan with the jaw movement recording of upper and lower gothic arch tracing members 12, 16.

FIG. 4 is a top occlusal view of lower gothic arch tracing member 12 illustrating anterior gothic arch tracing 19a, right posterior gothic arch tracing 19b, and left posterior gothic arch tracing 19c cut into recording material 18. Each gothic arch tracing 19a-c has an arrowhead shape with the apex being the centric relation position. These gothic arch tracings 19a-c are cut into recording material 18 by tracing pins 25 (see FIGS. 2 and 3) and have a complex three dimensional shape that reflects the precise border and protrusive movements of the mandible.

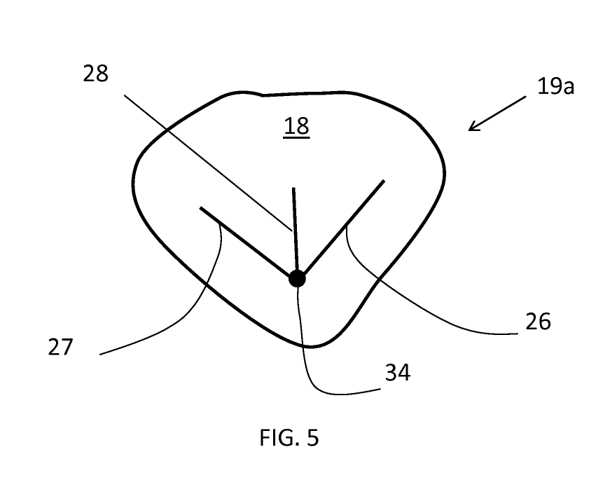

FIG. 5 is a top view of anterior gothic arch tracing 19a cut into recording material 18. Centric relation point 34 is located at the point where the individual mandibular movements making up the envelope of motion converge, i.e., the apex of the protrusive 28, right lateral 26 and left lateral 27 movements.

FIG. 6 illustrates the steps in scanning the tracing members. Physical combination 43 of upper and lower gothic arch tracing members 16, 12—which are locked in centric position using locking material 14—of intra oral gothic arch dental motion recording device 10 is first scanned (noted by solid arrow 108 pointing right) with contact, CT, laser or light to produce accurate three dimensional digital images (e.g., .stl file) of upper tissue surface 104 from impression material 13 (resulting in virtual upper impression 41) and lower tissue surface 106 from impression material 13 (resulting in virtual lower impression 42) in centric relation. Various light scanners from, for example, 3Shape, Dental Wings, and MEDIT are commercially available to perform the scan. In additional, other commercially available scanners may also be used.

Upper gothic arch tracing member 16 from physical combination 43 is then separated and scanned (noted by solid arrow 110 pointing up) separately to create a three dimensional digital image (e.g., .stl file) of upper tissue surface 104 from upper impression material 13 and occlusal surface 100 with tracing pins 25, resulting in virtual upper tissue surface 44. Lower gothic arch tracing member 12 from physical combination 43 is also separated and scanned (noted by solid arrow 112 pointing down) to create a three dimensional digital image (e.g., .stl file) of lower tissue surface 106 from lower impression material 13 and occlusal surface 102, resulting in virtual lower tissue surface 45, including fiducial markers 40, threaded post 21, and the plurality of gothic arch tracings 19a-c. Once scanning is complete, intra oral gothic arch dental motion recording device 10 is no longer needed and may be discarded.

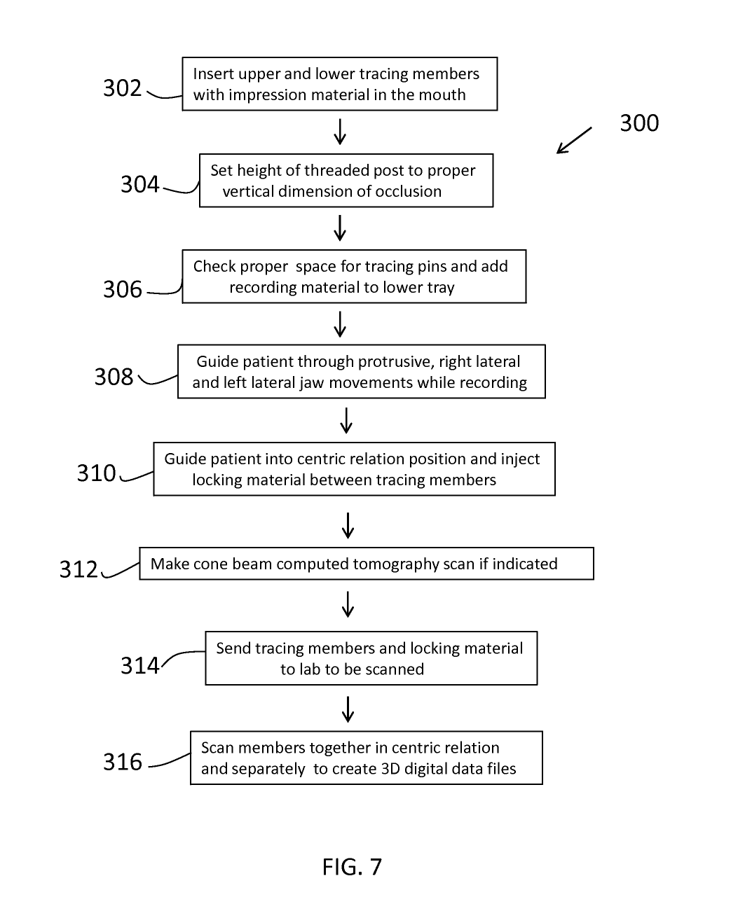

Referring now to FIG. 7, flow diagram 300 of the method of the present invention is provided illustrating the steps used to record jaw motion and to scan lower gothic arch tracing member 12 and upper gothic arch tracing member 16 of intra oral gothic arch dental motion recording device 10. Beginning with step 302, the dental professional inserts upper and lower gothic arch tracing members 16, 12 with impression material 13 in the patient's mouth. The height of threaded post 21 is set to proper vertical dimension of occlusion in step 304. Proper spacing for tracing pins 25 is checked and recording material 18 is added to lower tray 15, as indicated in step 306. The dental professional then guides the patient through protrusive, right lateral and left lateral jaw movements while recording same in step 308. Once the envelope of motion has been recorded, the dental professional then guides the patient into placing the patient's jaw into centric relation position. The dental professional then proceeds to inject locking material 14 between the upper and lower gothic tracing members 12, 16, as indicated in step 310. A cone-beam computed tomography scan is made, if indicated, in step 312. The dental professional then sends the upper and lower gothic tracing members 12, 16 and locking material 14 to a proper facility, such as a laboratory, to be scanned, as indicated in step 314. The upper and lower gothic tracing members 12, 16 are then scanned together in centric relation and then scanned separately to create 3D digital data files (see FIG. 6), as indicated in step 316.

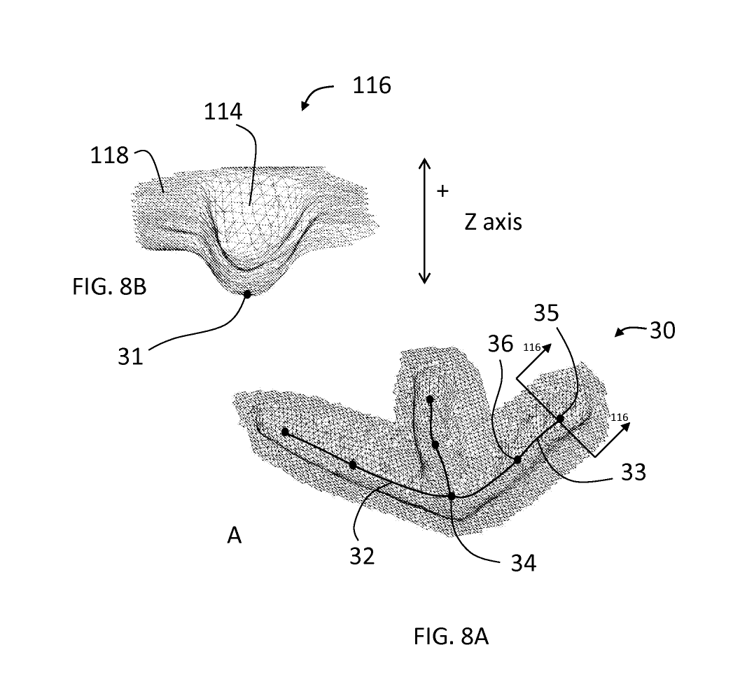

FIG. 8A is an .stl image and digital scan 30 of anterior gothic arch 19a. FIG. 8B is a cross sectional view and .stl image 116 of channel 114 within anterior gothic arch 19a—across 116-116 of FIG. 8A—created by tracing pin 25 (see FIG. 2) in recording material 18 (see FIG. 4). In FIG. 8B, .stl image 116 is cut in a cross section along the x-axis to view the .stl file (.stl image 116) which describes raw unstructured triangulated surface 118 by the unit normal and vertices (ordered by the right-hand rule) of the triangles using a three-dimensional Cartesian coordinate system. Simple mathematical algorithms can sort all triangle vertices to select only the lowest points, such as low point 31, which describe the path of tracing pin 25 through recording material 18. Simple mathematical algorithms can also sort and use the low points, e.g., low point 31, in channel 114 to create a polyline or spline of the path of the tracing pin in the recording material. FIG. 8A illustrates 3D splines 32 of anterior gothic arch tracing 19a.

The gothic arch tracing process can very accurately record jaw movement but the exact timing is not known. However, the starting point and the end point of each movement are known. For example, referring to FIG. 8A, centric relation point 34 is the common starting point for all three mandibular movements (i.e., protrusive, right lateral and left lateral). End point 35 is the end point of the movements, though the end point will be at different locations for each movement.

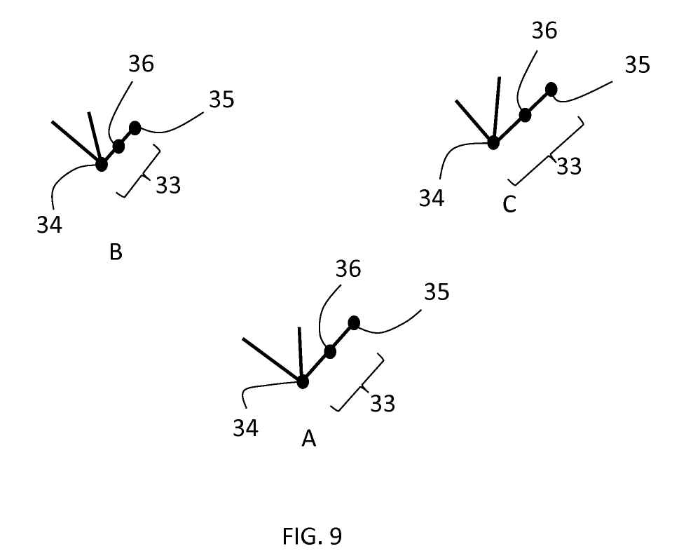

FIG. 9 illustrates the three gothic arch tracings 19a-c showing right lateral movement 33 created by tracing pin 25 (see FIG. 2) in recording material 18 (see FIG. 4). These three gothic arch tracings 19a-c are from the .stl scan of lower gothic arch tracing member 12. To illustrate the method of the present invention for using scan data to digitally record movement and to create a virtual computer model of the patient, right lateral movement 33 in FIG. 9 will be used for illustration purposes. However, the same process may be used for the protrusive and left lateral movements.

Many methods are used in computer science to move one virtual object in relation to another. Since three points define any object in space, they can be used in computer-aided design (CAD) software to move an object in computer space to another position in computer space precisely.

Still referring to FIG. 9, the splines of right lateral movement 33 for each of anterior gothic arch splines A, right posterior gothic arch splines B and left posterior gothic arch splines C are all of a different length. An excellent estimate of the position of the tracing pin along each of right lateral splines A, B, C can be obtained by bisecting each spline and locating midpoint 36 along the spline. This process of mathematically dividing the spline proportionally will generate Cartesian coordinate points to correctly move the virtual upper and lower impressions in computer space. This process may also be used to move virtual denture teeth to reproduce the motion that exists in the patient. This process may further still be used to mill manufactured dentures to be in conformity with a given patient jaw motion.

Still referring to FIG. 9, three gothic arch tracings corresponding to various locations within the patient's jaw are shown. Centric positions 34 of anterior gothic arch tracing A, right posterior gothic arch tracing B and left posterior gothic arch tracing C—i.e., three points—define the position of virtual upper impression 41 in relation to virtual lower impression 42 (see FIG. 6). To find the position of virtual upper impression 41 in relation to virtual lower impression 42 at the middle of right lateral movement or tracing 33, centric points 34 at anterior gothic arch tracing A, right posterior gothic arch tracing B and left posterior gothic arch tracing C may be used to make virtual upper impression 41 move from centric points 34 to bisector points 33 of anterior gothic arch tracing A, right posterior gothic arch tracing B and left posterior gothic arch tracing C. If end points 35 of anterior gothic arch tracing A, right posterior gothic arch tracing B and left posterior gothic arch tracing C—i.e., three points—are used to make virtual centric points 34 and virtual upper impression 41 move in computer space to a new position, the movement of the upper jaw to the end of the right lateral recording or movement 33 will be faithfully reproduced.

Simple moves from centric point 34, bisector point 33, and end point 35 have been used to illustrate the method of precisely creating virtual movement of the jaws in computer space. If the splines are divided further into smaller proportional divisions such as ¼, ⅙, 1/50 or 1/100 of the spline, then an even more accurate record of virtual movement may be made. If needed, the points (XYZ) can be translated into data as a sequence of six (6) degrees of freedom (X, Y, Z translations, and Rx, Ry, Rz Euler angles) as measured at some specific point on the mandible or maxillae.

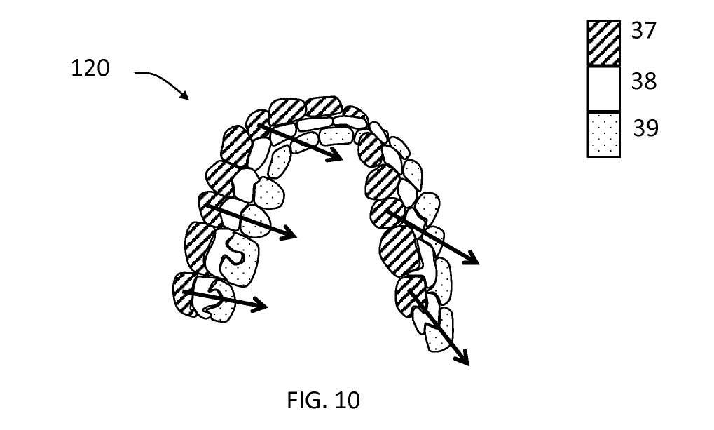

FIG. 10 is an occlusal view (i.e., toward the biting surface of posterior teeth) of upper virtual teeth set 120 in relation to virtual upper impression 41 (not shown). Virtual teeth 37 are set in centric relation position in relation to virtual lower impression 42 (not shown). Virtual teeth 38 have been moved in computer space to the bisected position along the right lateral spline. Virtual teeth 39 represent a virtual move of the teeth and virtual upper impression 41 to the end of the right lateral spline.

The arrows in FIG. 10 represent the direction of movement in the occlusal view, demonstrating that though the teeth travel together the same distance, the teeth do not necessarily travel in the same direction. This recording of movement can also be used to precisely refine the occlusal contacts (i.e., contacts between the upper and lower teeth when the jaw is in a closed position) of the digitally manufactured dentures.

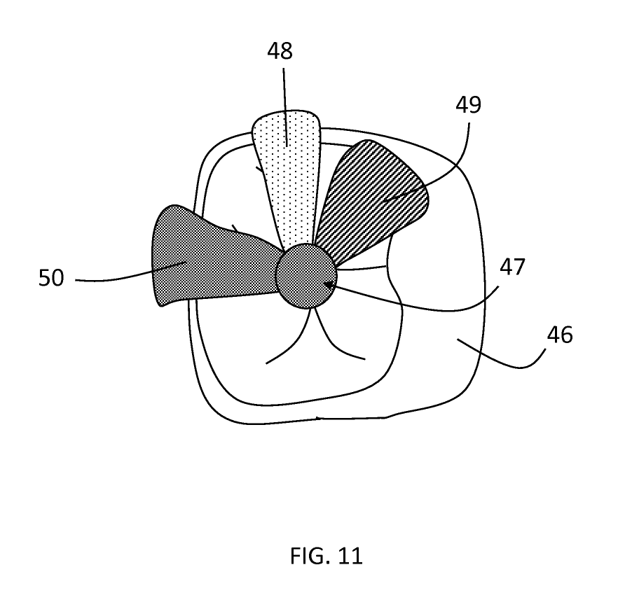

Teeth that are used in the manufacture of dentures have predetermined contours and contact relationships that may not be in harmony with the patient's jaw movement. Frequently, in the construction of dentures, it is necessary to have the denture teeth contact in a lingualized relationship with bilateral balance. FIG. 11 illustrates a left mandibular molar denture tooth 46. Upper lingual cusp 47 fits properly in the central fossae of lower left mandibular molar denture tooth 46 but has protrusive 48, right lateral 49 and left lateral 50 interferences when the mandible moves in these border motion positions that have been measured using the dental motion recording device of the present invention. By using the digital information obtained from the dental motion recording device of the present invention, the interferences can be removed using a number controlled mill to create bilateral balance in the molar occlusal relationship. The same process can be used to mill all the teeth in the processed denture to create bilateral balance or any other type of occlusal relationship.

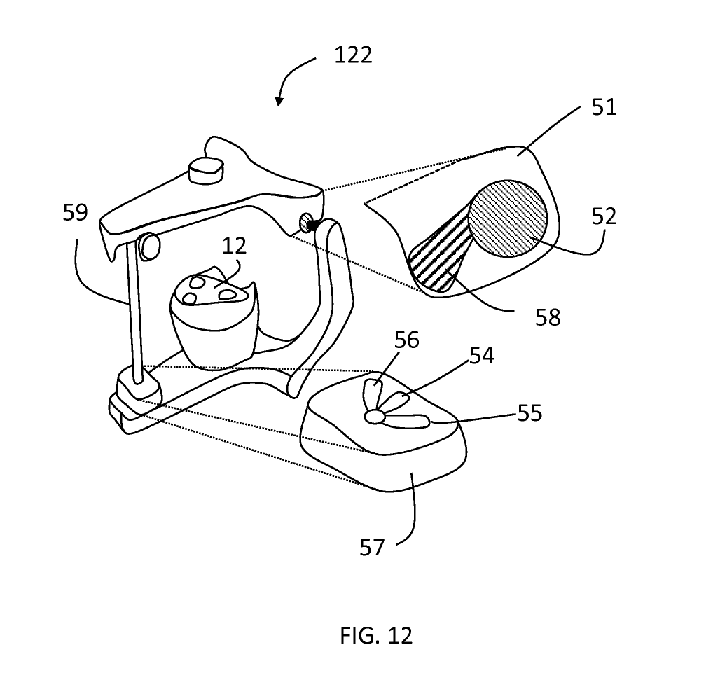

Referring now to FIG. 12, a typical arcon type semi-adjustable articulator 122 used in dentistry is shown. Articulator 122 is called “semi-adjustable” because this type of articulator cannot follow a patient's jaw motion but is an approximation to that movement. The present invention provides an inexpensive method of reproducing a patient's exact jaw movement by milling 58 the condylar housing 51 to allow condylar ball 52 of articulator 122 to travel in the same motion as the patient. It is also possible to mill anterior pin stop 57 such that incisal pin 59 of articulator 122 travels along a milled surface that has protrusive contour 54, right lateral contour 55, and left lateral contour 56 that will reproduce the exact movement of the patient's jaw.

The various embodiments described herein may be used singularly or in conjunction with other similar devices. The present disclosure includes preferred or illustrative embodiments of specifically described apparatuses, assemblies, methods and systems. Alternative embodiments of such apparatuses, assemblies, methods and systems can be used in carrying out the invention as claimed and such alternative embodiments are limited only by the claims themselves. Other aspects and advantages of the present invention may be obtained from a study of this disclosure and the drawings, along with the appended claims.

I claim:

1. An intra oral gothic arch dental motion recording device comprising:
an upper gothic arch tracing member having a top side and a bottom side, wherein said top side of said upper gothic arch tracing member is configured to fit against a patient's upper jaw;
a lower gothic arch tracing member having a top side and a bottom side in a complementary opposing position relative to said upper gothic arch tracing member, wherein said bottom side of said gothic arch tracing member is configured to fit against a patient's lower jaw;
a post removably connected to said top side of said bottom gothic arch tracing member;
a plurality of tracing pins connected to said bottom side of said upper gothic arch tracing member;
a plurality of fiducial markers on said bottom side of said upper gothic arch tracing member;
a plurality of recessed areas on said top side of said lower intra oral gothic arch tracing member; and
recording material, wherein said recording material covers said plurality of recessed areas.

2. The intra oral gothic arch dental motion recording device, as recited in claim 1, further comprising dental impression material between said top side of said upper intra oral gothic arch tracing member and the bottom surface of the upper jaw of the patient.

3. The intra oral gothic arch dental motion recording device, as recited in claim 2, further comprising dental impression material between said bottom side of said lower intra oral gothic arch tracing member and the top surface of the lower jaw of the patient.

4. The intra oral gothic arch dental motion recording device, as recited in claim 3, further comprising a first handle extending distally from and removably attached to said upper gothic arch tracing member;

5. The intra oral gothic arch dental motion recording device, as recited in claim 4, further comprising a second handle extending distally from and removably attached to said lower gothic arch tracing member;

6. The intra oral gothic arch dental motion recording device, as recited in claim 1, wherein said plurality of tracing pins are arranged in a triangular configuration within said upper gothic arch tracing member.

7. The intra oral gothic arch dental motion recording device, as recited in claim 6, wherein said plurality of fiducial markers are located adjacent to said plurality of tracing pins.

8. The intra oral gothic arch dental motion recording device, as recited in claim 7, wherein said post is threaded.

9. The intra oral gothic arch dental motion recording device, as recited in claim 1, wherein said upper intra oral gothic arch tracing member is configured to fit against said patient's lower jaw and wherein said lower intra oral gothic arch tracing member is configured to fit against said patient's upper jaw.

10. The intra oral gothic arch dental motion recording device, as recited in claim 1, wherein said intra oral gothic arch dental motion recording device is disposable.

11. A method for digitally recording jaw motion, said method comprising the steps of:
first mounting a tracing member having a contact surface to one of a patient's upper and lower jaws;
second mounting a recording member having a post to the other of said patient's jaws;
adjusting the distance between said tracing member and said recording member to bring said post of said recording member into contact with said contact surface of said tracing member when said jaws are held slightly apart;
locking said tracing member and said recording member in a fixed position;
forming a first set of three gothic arch traces, said traces defining a three dimensional envelope of motion;
scanning said first set of gothic arch traces and the tissue surfaces of said tracing member and of said recording member with a digital device;
translating the three dimensional shape of said first set of gothic arch traces obtained in said scanning step to a digital data set;
moving precisely a virtual model of said upper jaw in relation to a virtual model of said lower jaw from a first position to a second position, said moving step performed using said digital data set obtained from said translating step;
positioning virtual teeth to be in conformity to said envelope of motion of said virtual model of upper jaw and said virtual model of lower jaw;
milling manufactured dentures using said digital data set such that said dentures are in conformity with said patient's jaw movement, said milling step performed digitally; and
milling the condylar fossae and anterior pin stop area of an articulator such that said articulator faithfully reproduces said patient's jaw motion, said milling step performed digitally.
